(19) United States
(12) Patent Application Publication
(10) Pub. No.: US 2016/0201684 A1
(43) Pub. Date: Jul. 14, 2016

(54) COMPRESSOR AREA SPLITS FOR GEARED TURBOFAN

(71) Applicant: UNITED TECHNOLOGIES CORPORATION, Hartford, CT (US)

(72) Inventors: Frederick M. Schwarz, Glastonbury, CT (US); Paul H. Spiesman, Coventry, CT (US)

(21) Appl. No.: 14/912,187

(22) PCT Filed: Apr. 2, 2014
(86) PCT No.: PCT/US14/32599

§ 371 Date: Feb. 16, 2016

Related U.S. Application Data
(60) Provisional application No. 61/884,302, filed on Sep. 30, 2013.

(51) Int. Cl. F04D 19/02; F04D 25/04; B64D 11/06; F04D 29/56; F04D 29/54; F01D 5/06; F04D 29/32

(52) U.S. Cl. CPC F04D 19/02; F01D 5/06; F04D 25/045; F04D 29/321; F04D 29/563; F04D 29/542; F04D 29/325; B64D 11/06; F05D 2220/36

(57) ABSTRACT

A gas turbine engine has an upstream compressor having an upstream entrance area leading into a first vane upstream of the upstream compressor. A downstream compressor has an exit area at a leading edge of an exit vane for the downstream compressor. The entrance area divided by the exit area is greater than or equal to 13.8 and less than or equal to 15.3.

### RELATED APPLICATION

This application claims priority to provisional application Ser. No. 61/884,302, filed on Sep. 30, 2013.

### BACKGROUND OF THE INVENTION

This application relates to a geared turbofan having at least two compressor rotors and a range of ratios between certain areas in those two compressor rotors.

Gas turbine engines are known and, typically, include a fan delivering air into a compressor section, where it is compressed. The compressed air is delivered into a combustor where it is mixed with fuel and ignited. Products of this combustion pass downstream over turbine rotors driving them to rotate.

One known type of gas turbine engine includes two turbine rotors each driving a compressor rotor. A low pressure turbine rotor and a lower pressure compressor rotor had historically been tied to rotate at a single speed with a fan rotor.

More recently, a gear reduction has been placed between the fan rotor and the low pressure compressor.

### SUMMARY OF THE INVENTION

In a featured embodiment, a gas turbine engine comprises an upstream compressor having an upstream entrance area leading into a first vane upstream of the upstream compressor. A downstream compressor has an exit area at a leading edge of an exit vane for the downstream compressor. The entrance area divided by the exit area is greater than or equal to 13.8 and less than or equal to 15.3.

In another embodiment according to the previous embodiment, a ratio of a downstream entrance area defined at a first vane upstream of the downstream compressor rotor to the upstream entrance area is less than or equal to 0.500 and greater than or equal to 0.245.

In another embodiment according to any of the previous embodiments, a ratio of the exit area to the downstream entrance area is greater than or equal to 0.500 and less than or equal to 0.270.

In another embodiment according to any of the previous embodiments, a higher pressure turbine drives the downstream compressor rotor has two stages.

In another embodiment according to any of the previous embodiments, the downstream compressor rotor has more stages than the high pressure turbine rotor.

In another embodiment according to any of the previous embodiments, a fan rotor has a fan hub of a first diameter at a leading edge of a fan blade. The fan blade has a tip diameter at the leading edge. A ratio of the fan hub diameter to the fan tip diameter is less than or equal to 0.40.

In another embodiment according to any of the previous embodiments, the engine is utilized on a short range aircraft.

In another embodiment according to any of the previous embodiments, the short range aircraft has a single aisle between passenger section areas.

In another embodiment according to any of the previous embodiments, the gas turbine engine is utilized on a long-range aircraft.

In another embodiment according to any of the previous embodiments, the long-range aircraft has at least two aisles between passenger seating areas.

In another embodiment according to any of the previous embodiments, the first vane is a variable vane.

In another embodiment according to any of the previous embodiments, a ratio of the exit area to a downstream entrance area, at a first vane upstream of the downstream compressor rotor is greater than or equal to 0.145 and less than or equal to 0.270.

In another embodiment according to any of the previous embodiments, a higher pressure turbine drives the downstream compressor rotor has two stages.

In another embodiment according to any of the previous embodiments, the downstream compressor rotor has more stages than the high pressure turbine rotor.

In another embodiment according to any of the previous embodiments, the downstream compressor rotor has eight or nine stages.

In another embodiment according to any of the previous embodiments, a fan rotor has a fan hub of a first diameter at a leading edge of a fan blade. The fan blade has a tip diameter at the leading edge. A ratio of the fan hub diameter to the fan tip diameter is less than or equal to 0.40.

In another embodiment according to any of the previous embodiments, the engine is utilized on a short-range aircraft.

In another embodiment according to any of the previous embodiments, the short-range aircraft has a single aisle between passenger section areas.

In another embodiment according to any of the previous embodiments, the gas turbine engine is utilized on a long-range aircraft.

In another embodiment according to any of the previous embodiments, the long range aircraft has at least two aisles between passenger seating areas.

These and other features may be best understood from the following drawings and specification.

### BRIEF DESCRIPTION OF THE DRAWINGS

FIG. 1A schematically shows a gas turbine engine.

FIG. 1B schematically shows locations in an engine.

FIG. 2 is a table of certain characteristics of the FIG. 1 gas turbine engine.

FIG. 3 shows a schematic section of a seating area of a first airplane, which may receive a gas turbine engine of the type shown in FIG. 1.

FIG. 3B shows a schematic section of a seating area of a second airplane, which may receive a gas turbine engine of the type shown in FIG. 1.

### DETAILED DESCRIPTION

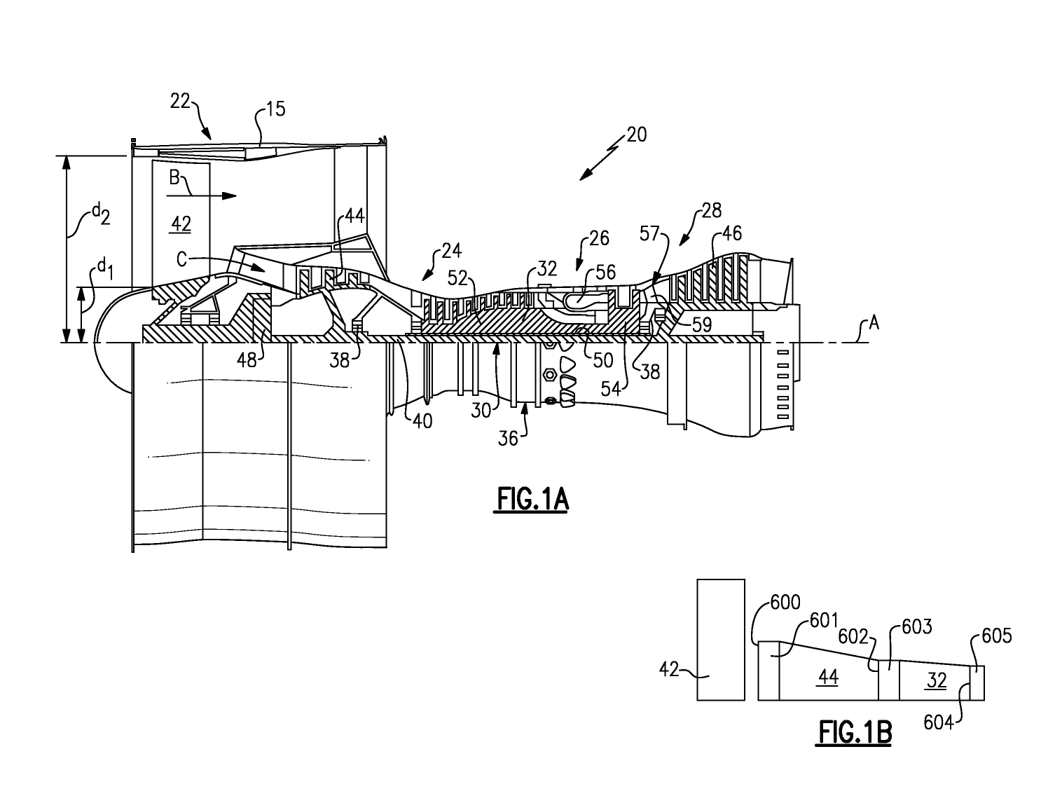

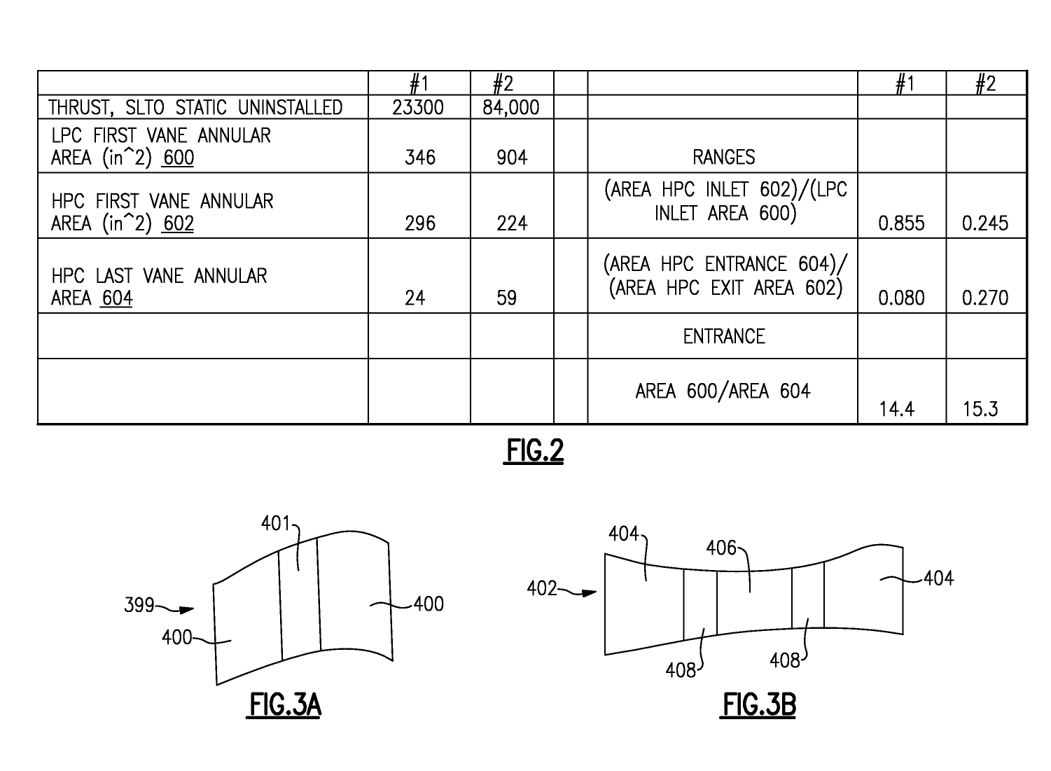

FIG. 1A schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. As used herein, a “low” pressure compressor or turbine experiences a lower pressure than the corresponding “high” pressure compressor or turbine.

A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption - also known as “bucket cruise Thrust Specific Fuel Consumption (‘TSFC’)” - is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

FIG. 1B shows several locations in engine 20.

Table 2 shows certain characteristics of the area at an entrance area 600 leading into a first vane 601 (immediately downstream of the fan 42 upstream of the upstream or first lower pressure compressor 44. Further, Table 2 shows area information with regard to an entrance area 602 at a vane 603 leading into a second or higher pressure compressor 32. Vane 603 may be a variable vane, where the vane can rotate to change an angle of incidence. Finally, an area 604 is at a leading edge of a downstream most exit vane 605 downstream of the higher pressure compressor 32. As used herein, the areas 600, 602, 604 are the areas of gas flow and as such are defined according to the following formula: [pi][[(radius from the engine axis A to the outer portion of the respective area)²−(radius from the engine axis A to the inner portion of the respective area)²], where pi=˜3.14.

As can be appreciated, two example engines are illustrated. Engine 1 is for a short range aircraft which is provided on a short range aircraft. Typically, a short range aircraft may be defined as having a total flight length of less than 3000 nautical miles.

As shown in FIG. 3A, a short-range aircraft 399 can also be defined as having two passenger seating areas 400 with a single aisle 401 intermediate the passenger seating areas. Typically, there would be 200 or less passengers in such a short-range aircraft. Much smaller numbers would also come within the scope of these type engines.

Engine 2 is for an ultra-long distance aircraft and may have twin aisles with passenger seating on opposed sides of the twin aisles and between the twin aisles. Such aircraft may typically fly for any number of hours and have standard flight lengths longer than ten hours as an example.

FIG. 3B shows an aircraft 402 which might utilize the engine 2, and has outer passenger seating areas 404 with a central passenger seating area 406. There are two intermediate aisles 408 intermediate the passenger seating areas 404 and 406.

While the longer range aircraft are defined as having two aisles, with the shorter range aircraft having a single aisle, this rule is not universal. As an example, there are shorter range aircraft having three central seats, and one outer seat on each side of a pair of aisles. However, in general, the single aisle/twin aisle distinction is useful.

The engine 1 will experience high utilization in cumulative hours at relatively high power. This is because the percentage of time it is at take-off and climb is a higher percentage than the longer range aircraft. The engine 2 will experience higher utilization at cruise conditions, and relatively low power.

The turbine section may have a two stage high pressure turbine 54 and the compressor section may have a high pressure compressor 52 with a larger number of stages such as eight to nine.

The present application improves the operation of the overall compressor section by providing a compressor wherein the ratio of the area at 604 to the area of 602 is greater than or equal to about 0.145 and less than or equal to about 0.270. The ratio of the area at 602 to the area at 600 is less than or equal to about 0.500 and greater than or equal to about 0.245. The ratio of the area at 600 to the area of 604 is greater than or equal to about 13.8 and less than or equal to about 15.3.

With these ranges, gas turbine engines can be developed which provide much more efficient operation than the geared turbofans as disclosed in the prior art.

The fan rotor has a fan hub of a first diameter d₁ at a leading edge of a fan blade 42, and the fan blade has a tip diameter d₂ at the leading edge, with a ratio of the fan hub diameter to the fan tip diameter being less than or equal to 0.40.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an upstream compressor having an upstream entrance area leading into a first vane upstream of the upstream compressor, and a downstream compressor having an exit area at a leading edge of an exit vane for said downstream compressor, and wherein the following ratio applies:
said entrance area divided by said exit area being greater than or equal to 13.8 and less than or equal to 15.3.

2. The gas turbine engine as set forth in claim 1, wherein a ratio of a downstream entrance area defined at a first vane upstream of said downstream compressor rotor to said upstream entrance area being less than or equal to 0.500 and greater than or equal to 0.245.

3. The gas turbine engine as set forth in claim 2, wherein a ratio of said exit area to said downstream entrance area being greater than or equal to 0.145 and less than or equal to 0.270.

4. The gas turbine engine as set forth in claim 3, wherein a higher pressure turbine for driving said downstream compressor rotor has two stages.

5. The gas turbine engine as set forth in claim 4, wherein said downstream compressor rotor having more stages than said high pressure turbine rotor.

6. The gas turbine engine as set forth in claim 3, wherein a fan rotor having a fan hub of a first diameter at a leading edge of a fan blade, and said fan blade having a tip diameter at said leading edge, with a ratio of said fan hub diameter to said fan tip diameter being less than or equal to 0.40.

7. The gas turbine engine as set forth in claim 6, wherein said engine is utilized on a short range aircraft.

8. The gas turbine engine as set forth in claim 7, wherein said short range aircraft having a single aisle between passenger section areas.

9. The gas turbine engine as set forth in claim 6, wherein said gas turbine engine is utilized on a long range aircraft.

10. The gas turbine engine as set forth in claim 9, wherein said long range aircraft having at least two aisles between passenger seating areas.

11. The gas turbine engine as set forth in claim 2, wherein said first vane is a variable vane.

12. The gas turbine engine as set forth in claim 1, wherein a ratio of said exit area to a downstream entrance area, at a first vane upstream of said downstream compressor rotor being greater than or equal to 0.145 and less than or equal to 0.270.

13. The gas turbine engine as set forth in claim 1, wherein a higher pressure turbine for driving said downstream compressor rotor has two stages.

14. The gas turbine engine as set forth in claim 13, wherein said downstream compressor rotor having more stages than said high pressure turbine rotor.

15. The gas turbine engine as set forth in claim 14, wherein said downstream compressor rotor having eight or nine stages.

16. The gas turbine engine as set forth in claim 1, wherein a fan rotor having a fan hub of a first diameter at a leading edge of a fan blade, and said fan blade having a tip diameter at said leading edge, with a ratio of said fan hub diameter to said fan tip diameter being less than or equal to 0.40.

17. The gas turbine engine as set forth in claim 1, wherein said engine is utilized on a short range aircraft.

18. The gas turbine engine as set forth in claim 17, wherein said short range aircraft having a single aisle between passenger section areas.

19. The gas turbine engine as set forth in claim 1, wherein said gas turbine engine is utilized on a long range aircraft.

20. The gas turbine engine as set forth in claim 19, wherein said long range aircraft having at least two aisles between passenger seating areas.
